(19) United States
(12) Patent Application Publication
(10) Pub. No.: US 2014/0117649 A1
(43) Pub. Date: May 1, 2014

(54) AIRBAG COVER WITH AT LEAST ONE FLAP

(71) Applicants: Maik Hoeing, Gescher (DE); Albert Roring, Gronau-Epe (DE); Rembert Schulze Wehninck, Muenchen (DE)

(72) Inventors: Maik Hoeing, Gescher (DE); Albert Roring, Gronau-Epe (DE); Rembert Schulze Wehninck, Muenchen (DE)

(21) Appl. No.: 14/063,437

(22) Filed: Oct. 25, 2013

(30) Foreign Application Priority Data
Oct. 31, 2012 (DE) 102012021315.8

(51) Int. Cl. B60R 21/215; B29C 51/20

(52) U.S. Cl. CPC B60R 21/215; B29C 51/20
USPC 280/728.3; 156/443

(57) ABSTRACT

A cover for an airbag comprises a rigid panel having a portion forming a flap defined by a plurality of sides all formed as breakaway lines and one of which also forms a hinge. The cover is made of a thermoplastic laminate that is formed along the hinge with a fold.

### FIELD OF THE INVENTION

The present invention relates to an airbag cover. More particularly this invention concerns an airbag cover.

### BACKGROUND OF THE INVENTION

A typical airbag cover has at least one flap that is defined by breakaway lines forming the flap edges in the material of the cover and/or along the edge of the material, and by a hinge edge. The cover tears along the predetermined breakaway lines so the flap can pivot about the hinge without tearing off the hinge after the airbag has been activated.

Airbag covers made of plastic have been disclosed that have one or two generally rectangular flaps each having predetermined breakaway lines along three sides that can tear after the airbag has been activated, and a hinge along the fourth side about which the flap pivots without tearing, thereby ensuring that the flap does not fly into the interior of the motor vehicle. This secure retention of the flap in the area of the hinge is achieved by supplemental nonbreaking filaments at the hinge, as disclosed in U.S. Pat. No. 8,348,303. These well-known airbag covers are expensive to produce.

### OBJECTS OF THE INVENTION

It is therefore an object of the present invention to provide an improved airbag cover with at least one flap.

Another object is the provision of such an improved airbag cover with at least one flap that overcomes the above-given disadvantages, in particular that is simple to manufacture and where the flap stays solidly attached after the airbag is activated.

### SUMMARY OF THE INVENTION

A cover for an airbag comprises a rigid panel having a portion forming a flap defined by a plurality of sides all formed as breakaway lines and one of which also forms a hinge. The cover is made of a thermoplastic laminate that is formed along the hinge with a fold.

After the airbag has been activated, the fold(s) or crease allows an additional travel distance or additional free travel path in the area of the hinge when the flap is pivoted out, thereby ensuring that the flap can be easily pivoted without tearing off at the hinge. Added to this is its simplicity of manufacture.

According to the invention the fold is formed by a pair of juxtaposed sides that are closely spaced or touching. These sides can be at least partially melted together and are parallel to each other.

The panel in accordance with the invention has inner and outer faces of which at least one is provided with a layer of thermoplastic polyester or polypropylene film. Furthermore it is a laminate having a plurality of first layers alternating with a plurality of second layers. The first layers each consist of a homogenous thermoplastic film of a polyolefin copolymer, polyester, or a polyester copolymer, and the second layers each consist of an array of strips or filaments of polypropylene or polyester.

This array can be orderly, that is a weave or a knit, or disorderly, that is a nonwoven. Either way, the flap has an outer face provided with a sprayed on layer of plastic.

An apparatus for making this cover has according to the invention a heated blade for deforming the reinforcement of the panel and forming the fold at the hinge in the panel. Means, for instance a tunnel-type oven, can be provided for preheating the panel before deformation by the blade. The apparatus further has according to the invention a support for holding the panel and formed with a groove into which the blade can extend to make the fold, as well as a clamp bar for holding the panel down on the support adjacent the groove. Two such clamp bars can flank the groove.

Furthermore according to the invention the blade has multiple parts for forming a W-, M-, or N-shaped fold. In addition a clamp bar can be provided that is movable perpendicular to the groove.

### BRIEF DESCRIPTION OF THE DRAWING

The above and other objects, features, and advantages will become more readily apparent from the following description, it being understood that any feature described with reference to one embodiment of the invention can be used where possible with any other embodiment and that reference numerals or letters not specifically mentioned with reference to one figure but identical to those of another refer to structure that is functionally if not structurally identical. In the accompanying drawing:

FIG. 1 is a detail of a vertical section through one embodiment of an airbag cover according to the invention;

FIG. 1a is an exploded view of a laminate used to make the airbag cover of this invention;

FIGS. 2a through 5c are schematic sections through the hinge of an airbag cover of V-shape, N-shape, W-shape, and M-shape in non-compressed in views 2a-5a, compressed form in FIGS. 2b-5b, and highly compressed form in FIGS. 2c-5c; and

FIG. 6 shows an apparatus for making the folds, grooves, and/or channels in the material of the cover or flap.

### SPECIFIC DESCRIPTION OF THE INVENTION

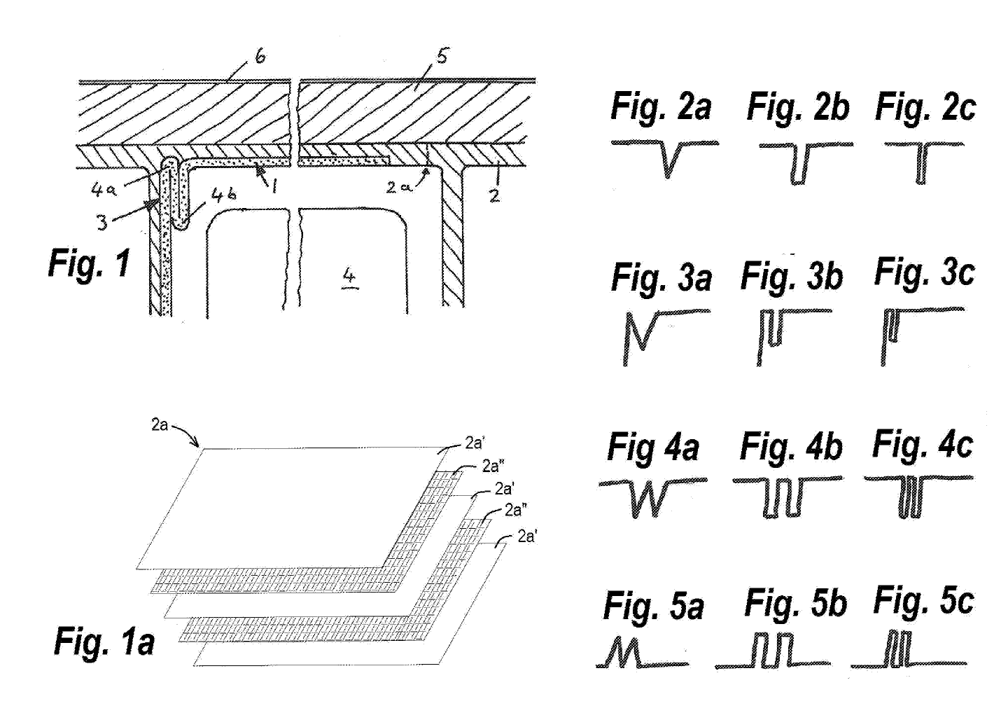

As seen in FIG. 1 an airbag cover 2 is made from a rigid and/or stiff plastic sheet and is thus a relatively thin, flat, level, solid object of completely uniform thickness and limited elasticity (as opposed to a film).

As shown in FIG. 1a, the airbag is made from a laminate 2a having a plurality of first layers 2a′ alternating with a plurality of second layers 2a″. The first layers 2a′ each consist of a homogenous thermoplastic film of a polyolefin copolymer, polyester, or a polyester copolymer. The second layers 2a″ each consisting of an array of strips or filaments of polypropylene or polyester.

Thus the airbag cover 2 wholly made of thermoplastic synthetic material, in particular thermoplastic polypropylene (PP). It is a self-reinforced sheet laminate in which the layers 2a′ of homogenous polypropylene films, copolymer polyolefin films, homogenous polyester films, or copolymer films alternate with reinforcing layers 2a″ made of polypropylene or polyester strip, or that include such strip. The strips here form a thin layer in which they are oriented, in particular as a fabric, or are woven, or lie in a random crisscross pattern. The film layers and reinforcing strip layers alternate, and the total number of strip layers is at least two, in particular three to eight layers, with an overall thickness of between 0.35 mm and 3 mm. When pressure or heat is applied, all of the layers melt together to form a single panel that is made only of polypropylene or polyester layers.

In alternative embodiments, the additional reinforcing layers located between or on the film layers comprise fibers or filaments in place of strips, these again being made of polypropylene or polyester films and arranged in ordered fashion (also in the form of fabric) or random fashion.

In a first alternative approach of a further embodiment, the top face and/or the bottom face of the material of the cover 2 is backed with a thermoplastic film made of polyester or polypropylene. In a second alternative, the top face and/or the bottom face of the material of the cover is backed with a nonwoven fabric or a glass-fiber fabric.

One or two generally rectangular flaps 1 covering an airbag 4 are incorporated in the panel-like airbag cover 2 in such a way that predetermined breakaway lines are provided on three sides of each flap 1 within the cover panel, which lines penetrate the entire panel and release the flap 1 after the airbag 4 has been activated. A longitudinal hinge area including a hinge 3 is located at the fourth edge so as to pivot without tearing after triggering. Secure protection against tearing is achieved, in particular by using strips, fibers, or filaments in the reinforcing layers.

In another embodiment, not shown, the cover is embedded in the bottom side of a plastic layer (in particular injection-molded layer made of polypropylene with glass fibers) such that the predetermined breakaway line is not of the cover material at least on one side but is instead in the plastic layer outside the material of the cover.

In another embodiment, secure protection against tearing off is further enhanced by forming a fold, a groove, or a channel at the hinge 3 that run longitudinally along the hinge or of the flap edge, thereby generating an additional length of material perpendicular to longitudinal extent of the hinge. This additional length of material in the hinge area ensures there is a sufficient length of travel when the flap is pivoted about the hinge, thereby ensuring that the flap does not tear.

FIG. 1 is a sectional view of an embodiment comprising an airbag cover or flap 1 over the airbag 4 that is embedded in the bottom side of airbag cover 2 made of plastic, where the airbag cover 2 is an injection-molded layer of polypropylene, in particular comprising glass fibers. The cover 2 includes predetermined breakaway lines on three sides that tear when the airbag 4 is activated.

The cover or flap 1 that is made of the above-referenced self-reinforcing thermoplastic composite forms the hinge 3 on one edge due to the fact that the panel-like material is folded twice, with the result that two folds 4a, 4b are created there that run along the edge, and thus the hinge has the shape of a compressed “N”. The folds 4a, 4b here can be in contact with each other, as in FIG. 1 and FIG. 3c, or can be spaced, as shown in FIGS. 3 a and 3b. The production method is further simplified by adhesively bonding the crease or by melting the surface of the self-reinforcing composite. This melting can cover the entire surface or can also cover only part of it. This adhesive bonding ensures a consistent, dimensionally stable crease

The top of the airbag cover 1, 3 is also covered with a layer of foam 5 whose outer surface supports an outer skin that tears along with the rest.

As FIGS. 2a-c, 4a-c, and 5a-c show, the crease in the area of hinge 3 can also be of single type (FIGS. 2a-c), or of a multiple type, in particular three-part type (FIGS. 4a-c and 5a-c), and thus include one, two, or more folds. The crease can also be made of grooves or channels.

Instead of one flap, the material of the cover of an airbag can also form two flaps that are separated from each other by a predetermined breakaway line, one hinge each including folds or creases at both outer sides of the flaps where the hinges together with the folds or creases and the central predetermined breakaway line are parallel to each other.

To form the fold(s), groove(s), or channel(s) a heated blade is used by being pressed into the panel of the cover of the flap 1 at the hinge, thereby deforming the thermoplastic material, part or all of the material's area preferably also being preheated before being deformed.

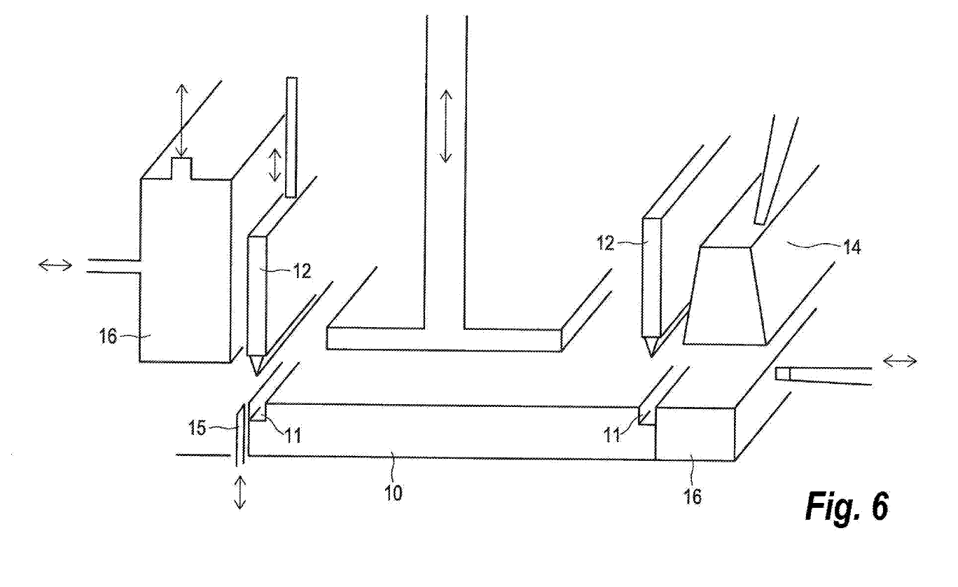

The machine shown in FIG. 6 for generating fold(s) 4a, 4b, groove(s), and/or channel(s) in the panel-like material includes a base 10 on which the panel is laid. The base 10 here has at least one groove 11 over which a blade 12 is supported so as to be vertically movable in order to press the material of the panel into the groove when moving downward, thereby forming a fold in the panel and thus creating the flap 1, as illustrated in cross-section in FIG. 2a. The panel is held by at least two clamp bars 13 and 14 that press the panel onto the base 10 at both sides of the groove 11 during hot or cold shaping.

Whenever single folds are to be produced as in FIGS. 3a-c, the machine also has a second blade 15 traveling upward from below, and a lateral horizontally traveling jaw 16. Three blades are provided in the case of triple folds as in FIGS. 4a-c and 5a-c.

With hot shaping, the material of the panel passes through a pre-heating oven that heats it to a temperature of between 90° C. and 100° C. before the panel is creased in the machine.

The essential design of the operating unit thus includes the following features:

a supply of flat panels,

a continuous oven to preheat the material to 90° C.

guides for the shaping tools

partial/full heating to >110° C.

deforming to create the specified shape

cooling the shaped material

ejection on reaching a predetermined temperature.

The panel supply that functions to hold the separate cut-to-size sheets, is continuously adjustable in terms of the outside geometry of the cut-to-size sheets, and is of a maximum size measuring 400 mm×400 mm. Its outlet through which the individual panels are removed is also continuously adjustable, thereby allowing the widest range of different thicknesses to be processed. For monitoring purposes, photoelectric or other sensors function to prevent empty operation by being able to emit acoustic or visual signals.

The material is preheated to 90° C. in order to release latent stresses that are created by the production process for thermoplastic self-reinforcing composite material. This preheating can be implemented by contact heat, radiant heat, or convective heat. Convective heat is used in the described operating unit to effect heating of the cut-to-size sheets, while only natural convection is applied here without supplementally introduced convection, the continuous oven being insulated so as to minimize energy loss. The intended heating time is at least 30 seconds, preferably 4 minutes.

Once the latent stresses in the cut-to-size sheet have been relaxed by the preheating step, these cut-to-size sheets must be aligned so as to ensure the shaping is being effected consistently at the same location. This is done by lateral stops that are adjusted based on workpiece size.

Heating the material to the requisite shaping temperature is also done using the described methods (contact heat, radiant heat, convective heat). Heating is effected in this description of the operating unit by contact heat using metal plates in which heating inserts are incorporated. These plates are preferably divided into four zones that are controlled separately. The temperature required for shaping is in the range of >110° C., preferably around 145° C., the temperature being permanently monitored by sensors. The size of the heating plates is designed for the maximum size of the cut-to-size sheets at 400 mm×400 mm, as is the entire operating unit.

Shaping the cut-to-size sheets is effected by pushing in heatable blades 12 and 15 to form a crease in the material. A precise and, in particular uniform crease is especially critical for the airbag cover. In order to enable this to occur, a die 13 is lowered onto the cut-to-size sheet before the blades plunge into the material and this then holds the material in position during shaping. If shaping to create a 3-D component is required, this die can be provided with the requisite shape so as to enable it to create rounded areas or similar 3-D shapes. A positive or negative contour is provided on the die or to the plate. Lowering the die then enables the 3-D geometry to be created in the material. It is then also possible to form additional creases by means of the described blades.

If a crease is required that has a closed rounded configuration, the blade is then withdrawn after immersion and lateral jaws 16 press the crease together since no injection-molding compound must enter the fold during the back-injection process as this could bond the fold together.

The component is held in position until the temperature has fallen below the deformation temperature, preferably 70° C. All of the materials that come into contact with the material are heated to a temperature of at least 60° C. so as to prevent temperature shock during shaping.

The shaping process is thus comprised multiple individual steps that are listed below in the order of processing.

separating (punching, laser cutting, water-jet cutting) of the panel into the appropriate size as a function of the model,

heating (contact heat, radiant heat, convective heat; combinations of multiple variants) the separated cut-to-size sheets to approximately 90° C. so as to relax stresses in the material,

aligning the separated cut-to-size sheets,

heating (contact heat, radiant heat, convective heat; combinations of multiple variants) the separated cut-to-size sheets to >100° C. in at least regions where shaping is to be effected, or of the entire area,

applying a movable a cold or heated blade, and creating additional deformations as required for the component,

cooling the deformed components to below 100° C., preferably below 60° C., and

removing the deformed components that have cooled below the deformation temperature.

The shaping process for self-reinforcing thermoplastic composites is not restricted, however, only to making the fold along the hinge line; in fact, it is possible to employ the above-described process to create other shapes of deformation such as for example rounded areas in the overall component, thus enabling not only a free length section to be formed but also a 3-D component.

We claim:

1. A cover for an airbag, wherein the cover comprises a rigid panel having a portion forming a flap defined by a plurality of sides all formed as breakaway lines and one of which also forms a hinge, the cover being made of a thermoplastic laminate that is formed along the hinge with a fold.

2. The airbag cover defined in claim 1, wherein the fold is formed by a pair of juxtaposed sides that are closely spaced or touching.

3. The airbag cover defined in claim 2, wherein the sides of the fold are at least partially melted together.

4. The airbag cover defined in claim 2, wherein the sides of the fold are parallel to each other.

5. The airbag cover defined in claim 1, wherein the panel has inner and outer faces of which at least one is provided with a layer of thermoplastic polyester or polypropylene film.

6. The airbag cover defined in claim 1, wherein the panel is a laminate having a plurality of first layers alternating with a plurality of second layers, the first layers each consisting of a homogenous thermoplastic film of a polyolefin copolymer, polyester, or a polyester copolymer, the second layers each consisting of an array of strips or filaments of polypropylene or polyester.

7. The airbag cover defined in claim 6, wherein the array is a weave.

8. The airbag cover defined in claim 6, wherein the array is a nonwoven.

9. The airbag cover defined in claim 1, wherein the flap has an outer face provided with a sprayed on layer of plastic.

10. An apparatus for making an cover comprising a rigid panel having a portion forming a flap defined by a plurality of sides all formed as breakaway lines and one of which also forms a hinge, the cover being made of a thermoplastic laminate having a layer of polyester or polypropylene reinforcement and formed along the hinge with a fold, the apparatus comprising:
a heated blade for deforming the reinforcement of the panel and forming the fold at the hinge in the panel.

11. The apparatus defined in claim 10, further comprising:
means for preheating the panel before deformation by the blade.

12. The apparatus defined in claim 10, further comprising:
a support for holding the panel and formed with a groove into which the blade can extend to make the fold.

13. The apparatus defined in claim 12, further comprising:
a clamp bar for holding the panel down on the support adjacent the groove.

14. The apparatus defined in claim 13, wherein two such clamp bars flank the groove.

15. The apparatus defined in claim 10, wherein the blade has multiple parts for forming a W-, M-, or N-shaped fold.

16. The apparatus defined in claim 10, further comprising:
a clamp bar movable perpendicular the groove.
